(19) United States
(12) Patent Application Publication
(10) Pub. No.: US 2024/0414545 A1
(43) Pub. Date: Dec. 12, 2024

(54) METHOD AND APPARATUS FOR PROVIDING SECURITY ANALYSIS SERVICE IN COMMUNICATION SYSTEM

(71) Applicant: SAMSUNG ELECTRONICS CO., LTD., Suwon-si (KR)

(72) Inventors: Donghyun JE, Suwon-si (KR); Dongmyung KIM, Suwon-si (KR)

(21) Appl. No.: 18/737,884

(22) Filed: Jun. 7, 2024

(30) Foreign Application Priority Data
Jun. 7, 2023 (KR) 10-2023-0073144

(51) Int. Cl. H04W 12/126; H04W 8/18

(52) U.S. Cl. CPC H04W 12/126; H04W 8/18

(57) ABSTRACT

The disclosure relates to a 6G communication system for accomplishing a high data transmission speed and an ultra-low latency after 4G and 5G communication systems. According to an embodiment, a method performed by a first node in a communication system may be provided. The method may include: obtaining vulnerability-related information related to the communication system; receiving a first message including a request for a security-related service from a second node; and providing a second message including the security-related service, based on the vulnerability-related information, after receiving the request for the security-related service.

### CROSS-REFERENCE TO RELATED APPLICATION

This application is based on and claims priority under 35 U.S.C. § 119 to Korean Patent Application No. 10-2023-0073144, filed on Jun. 7, 2023, in the Korean Intellectual Property Office, the disclosure of which is herein incorporated by reference in its entirety.

### BACKGROUND

### 1. Field

The disclosure relates generally to a communication system and, more particularly, to a method and an apparatus for providing a security analysis service in a communication system.

### 2. Description of Related Art

A review of the development of wireless communication from generation to generation shows that the development has mostly been directed to technologies for services targeting humans, such as voice-based services, multimedia services, and data services. It is expected that connected devices which are exponentially increasing after commercialization of 5th generation (5G) communication systems will be connected to communication networks. Examples of things connected to networks may include vehicles, robots, drones, home appliances, displays, smart sensors installed in various infrastructures, construction machines, factory equipment, and the like. Mobile devices are expected to evolve into various formfactors, such as augmented reality glasses, virtual reality headsets, and hologram devices. In order to provide various services by connecting hundreds of billions of devices and things in the 6G era, there have been ongoing efforts to develop improved 6G communication systems. For these reasons, 6G communication systems are referred to as “beyond-5G” systems.

6G communication systems, which are expected to be implemented approximately by 2030, will have a maximum transmission rate of tera (1,000 giga)-level bps and a radio latency of 100μ sec. Thus, 6G communication systems will be 50 times as fast as 5G communication systems and have the 1/10 radio latency thereof.

In order to accomplish such a high data transmission rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, a technology capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the frequency efficiencies and system networks, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; a network structure innovation technology for supporting mobile nodes B and the like and enabling network operation optimization and automation and the like; a dynamic spectrum sharing technology though collision avoidance based on spectrum use prediction, an artificial intelligence (AI)-based communication technology for implementing system optimization by using AI from the technology design step and internalizing end-to-end AI support functions; and a next-generation distributed computing technology for implementing a service having a complexity that exceeds the limit of UE computing ability by using super-high-performance communication and computing resources (mobile edge computing (MEC), clouds, and the like). In addition, attempts have been continuously made to further enhance connectivity between devices, further optimize networks, promote software implementation of network entities, and increase the openness of wireless communication through design of new protocols to be used in 6G communication systems, development of mechanisms for implementation of hardware-based security environments and secure use of data, and development of technologies for privacy maintenance methods.

It is expected that such research and development of 6G communication systems will enable the next hyper-connected experience in new dimensions through the hyper-connectivity of 6G communication systems that covers both connections between things and connections between humans and things. Particularly, it is expected that services such as truly immersive XR, high-fidelity mobile holograms, and digital replicas could be provided through 6G communication systems. In addition, with enhanced security and reliability, services such as remote surgery, industrial automation, and emergency response will be provided through 6G communication systems, and thus these services will be applied to various fields including industrial, medical, automobile, and home appliance fields.

### SUMMARY

An embodiment of the disclosure may provide a method and an apparatus for providing a security analysis service in a communication system.

The technical subjects pursued in the disclosure may not be limited to the above-mentioned matters, and other technical subjects which are not mentioned may be considered from the following description of embodiments of the disclosure by those skilled in the art to which the disclosure pertains.

According to an embodiment, a method performed by a first node in a communication system may be provided.

According to an embodiment, the method may include: obtaining vulnerability-related information related to the communication system.

According to an embodiment, the method may include: receiving a first message including a request for a security-related service from a second node.

According to an embodiment, the method may include: providing a second message including the security-related service, based on the vulnerability-related information, after receiving the request for the security-related service.

According to an embodiment, the first node may be a first network function (NF) included in a core network of the communication system and configured to provide the security-related service.

According to an embodiment, in case that the second message is provided to a second NF included in a core network of the communication system, the second message may be provided to the second NF, based on a service-based interface (SBI) exhibited by the first node.

According to an embodiment, in case that the second message is provided to an application function (AF), the second message may be provided from the first node to the AF via a network exposure function (NEF) included in a core network of the communication system, an SBI exhibited by the first node may be configured between the first node and the NEF, and an outbound restriction may be applied to the second message provided to the AF, based on exposure mapping, by the NEF.

According to an embodiment, in case that the vulnerability-related information is obtained from a third NF included in a core network of the communication system, the obtaining of vulnerability-related information may include: transmitting a message including a request for the vulnerability-related information to the third NF via an SBI exhibited the third NF; and obtaining a message including the vulnerability-related information from the third NF via the SBI exhibited the third NF.

According to an embodiment, the vulnerability-related information may include at least one requested by a message including a request for the vulnerability-related information from among a list of network entities (NEs) on known vulnerabilities included in the communication network, a list of UEs on known vulnerabilities included in the communication network, a list of NFs on known vulnerabilities included in the communication network, a list of access networks (Ans) on known vulnerabilities, included in the communication network, a list of vendors on known vulnerabilities, a list of products on known vulnerabilities, a list of versions on known vulnerabilities, common vulnerabilities and exposure (CVE), a common vulnerability scoring system (CVSS), CVE numbering authority (CNA), or common weakness enumeration (CWE).

According to an embodiment, the security-related service may be based on an analysis result regarding the vulnerability-related information.

According to an embodiment, in connection with obtaining analysis result regarding the vulnerability-related information, a correlation between at least some of multiple nodes included in the communication system may be identified based on predefined correlation information.

According to an embodiment, in case that the first message includes information related to the number of times the second message is provided, the second message may be provided the number of times identified based on the information related to the number of times the second message is provided.

According to an embodiment, in case that the first message includes information related to periodic provision regarding the second message, the second message may be provided periodically.

According to an embodiment, in case that the first message includes information related to non-periodic provision regarding the second message, the second message may be provided non-periodically.

According to an embodiment, in case that the first message includes information related to an object of a security-related service, the second message may be provided based on vulnerability-related information related to the object.

According to an embodiment, in case that the first message includes information regarding a target address of the second message, the second message may be provided to a node identified by the target address.

According to an embodiment, based on that the request for the security-related service is a request for subscription to the security-related service, the second message may be provided based on subscription.

According to an embodiment, based on that the request for the security-related service is a one-time request, the second message is provided for one time.

According to an embodiment, the information related to the number of times the second message is provided, the information related to periodic provision, the information related to non-periodic provision, and the information regarding a target address may be included in the first message, based on a case in which the request for the security-related service is a request for subscription to the security-related service.

According to an embodiment, the second message may include: information regarding a timestamp indicating a timepoint at which the first node generated the security-related service based on the vulnerability-related information; and information regarding a validity duration from a timepoint at which the security-related service is generated to a timepoint at which the security-related service is identified as being valid.

According to an embodiment, a first node of a communication system may be provided.

According to an embodiment, the first node may include: a transceiver; and a processor connected to the transceiver.

According to an embodiment, the processor may be configured to: obtain vulnerability-related information related to the communication system.

According to an embodiment, the processor may be configured to: receive a first message including a request for a security-related service from a second node.

According to an embodiment, the processor may be configured to: provide a second message including the security-related service, based on the vulnerability-related information, after receiving the request for the security-related service.

An embodiment of the disclosure described above is only a part of exemplary embodiments of the disclosure, and various embodiments reflecting technical features of an embodiment of the disclosure may be derived and understood by those skilled in the art, based on the following detailed description.

According to an embodiment of the disclosure, a method and an apparatus for providing a security analysis service in a communication system may be provided.

According to an embodiment of the disclosure, a security structure based on a zero trust architecture may be provided.

According to an embodiment of the disclosure, security may be improved in a communication system.

Advantageous effects obtainable from an embodiment of the disclosure may not be limited to the above-mentioned effects, and other effects which are not mentioned may be clearly understood, based on the following descriptions, by those skilled in the art to which the disclosure pertains.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The accompanying drawings are for helping understanding of an embodiment of the disclosure, and provides an embodiment of the disclosure in conjunction with the detailed description. However, technical features of the disclosure are not limited to specific drawings, and features disclosed in respective drawings may be combined to construct a new embodiment. Reference numerals in respective drawings denote structural elements:

FIG. 1 illustrates a wireless communication system according to various embodiments of the present disclosure;

FIG. 2 illustrates examples of an SAF according to an embodiment of the present disclosure;

FIG. 3 illustrates an example of a procedure related to security analytics service subscription according to an embodiment of the present disclosure;

FIG. 4 illustrates an example of a procedure related to security analytics service subscription according to an embodiment of the present disclosure;

FIG. 5 illustrates an example of a security analysis request procedure according to an embodiment of the present disclosure;

FIG. 6 illustrates an example of a security analysis request procedure according to an embodiment of the present disclosure;

FIG. 7 illustrates an example of operations of a first node according to an embodiment of the present disclosure;

FIG. 8 illustrates an example of the structure of a node according to an embodiment of the present disclosure;

FIG. 9 illustrates an example of the structure of a UE according to an embodiment of the present disclosure; and

FIG. 10 illustrates an example of the structure of a base station according to an embodiment of the present disclosure.

### DETAILED DESCRIPTION

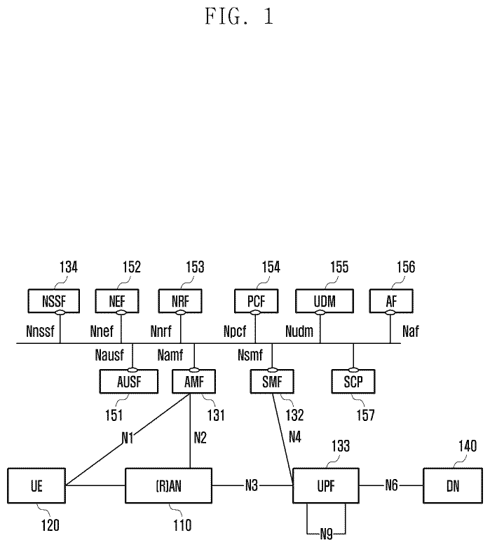

FIGS. 1 through 10, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

Hereinafter, embodiments of the disclosure will be described in detail with reference to the accompanying drawings.

In describing the embodiments, descriptions related to technical contents well-known in the relevant art and not associated directly with the disclosure will be omitted.

Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Furthermore, the size of each element does not completely reflect the actual size. In the respective drawings, identical or corresponding elements are provided with identical reference numerals.

The advantages and features of the disclosure and ways to achieve them will be apparent by making reference to embodiments as described below in detail in conjunction with the accompanying drawings.

However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference signs indicate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, such as a field programmable gate array (FPGA) or an application specific integrated circuit (ASIC), which performs a predetermined function. However, the “unit” does not always have a meaning limited to software or hardware. The “unit” may be constructed either to be stored in an addressable storage medium or to execute one or more processors. Therefore, the “unit” includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit.” Moreover, the elements and “units” may be implemented to reproduce one or more CPUs within a device or a security multimedia card.

In the following description, some of terms and names defined in the 3rd generation partnership project (3GPP) standards (standards for 5G, NR, LTE, or similar systems) may be used for the sake of descriptive convenience. In addition, terms and names used in existing communication systems or newly defined in next-generation communication systems (e.g., 6G and beyond-5G systems) to which the disclosure is applicable may also be used. Use of these terms is not intended to limit the disclosure by the terms and names, and the disclosure may be applied in the same way to systems that conform other standards, and may be changed into other forms without departing from the technical idea of the disclosure. The embodiments of the disclosure may be easily applied to other communication systems through modifications.

As used here in, it will be understood that the singular expressions “a,” “an,” and “the” include plural expressions unless the context clearly indicates otherwise.

As used in an embodiment of the disclosure, the terms including an ordinal number, such as “a first” and “a second” may be used to described various elements, but the corresponding elements should not be limited by such terms. The above terms are used merely for the purpose of distinguishing one element from other elements. For example, a first element may be termed a second element, and similarly, a second element may be termed a first element without departing from the scope of protection of the disclosure.

As used in an embodiment of the disclosure, the term “and/or” includes any one or combinations of a plurality of relevant items enumerated.

The terms as used in an embodiment of the disclosure are merely used to describe specific embodiments, and are not intended to limit the disclosure. A singular expression may include a plural expression unless they are definitely different in a context. As used herein, the expression “include” or “have” are intended to specify the existence of mentioned features, numbers, steps, operations, elements, components, or combinations thereof, and should be construed as not precluding the possible existence or addition of one or more other features, numbers, steps, operations, elements, components, or combinations thereof.

As used in an embodiment of the disclosure, the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

As used in the disclosure, the expression “greater than” or “less than” is used to determine whether a specific condition is satisfied or fulfilled, but this is intended only to illustrate an example and does not exclude “greater than or equal to” or “equal to or less than.” A condition indicated by the expression “greater than or equal to” may be replaced with a condition indicated by “greater than,” a condition indicated by the expression “equal to or less than” may be replaced with a condition indicated by “less than,” and a condition indicated by “greater than and equal to or less than” may be replaced with a condition indicated by “greater than and less than.”

Furthermore, embodiments of the disclosure will be described using terms used in some communication standards (e.g., the 3rd generation partnership project (3GPP)), but they are for illustrative purposes only. The embodiments of the disclosure may be easily applied to other communication systems through modifications.

Before the detailed description of the disclosure, examples of construable meanings of some terms used herein are given below. However, it should be noted that the terms are not limited to the examples of the construable meanings as given below.

In the disclosure, a terminal (or communication terminal) is an entity that communicates with a base station or any other terminal, and may be referred to as a node, a user equipment (UE), a next generation UE (e.g., NG UE), a mobile station (MS), a device, a terminal, or the like. The terminal may include at least one of a smartphone, a tablet personal computer (PC), a mobile phone, a video phone, an electronic book reader, a desktop PC, a laptop PC, a netbook computer, a personal digital assistant (PDA), a portable multimedia player (PMP), an MP3 player, a medical device, a camera, and a wearable device. Also, the terminal may include at least one of a television, a digital video disk (DVD) player, an audio, a refrigerator, an air conditioner, a vacuum cleaner, an oven, a microwave oven, a washing machine, an air purifier, a set-top box, a home automation control panel, a security control panel, a media box, a game console, an electronic dictionary, an electronic key, a camcorder, and an electronic photo frame. In addition, the terminal may include at least one of various medical devices (e.g., various portable medical measuring devices (blood glucose monitoring device, heart rate monitoring device, blood pressure measuring device, body temperature measuring device, etc.), magnetic resonance angiography (MRA), magnetic resonance imaging (MRI), computed tomography (CT) machine, ultrasonic machine, etc.), a navigation device, a global positioning system (GPS) receiver, an event data recorder (EDR), a flight data recorder (FDR), a vehicle infotainment device, electronic equipment for a ship (e.g., ship navigation device, gyro-compass, etc.), avionics, a security device, an automobile head unit, a home or industrial robot, a drone, an automatic teller's machine (ATM) in banks, point of sales (POS) in a shop, or Internet of things devices (e.g., light bulb, various sensors, electric or gas meter, sprinkler device, fire alarm, thermostat, streetlamp, toaster, sporting goods, hot water tank, heater, boiler, etc.). Furthermore, the terminal may include various types of multimedia systems capable of communication functions. The disclosure is not limited by the above examples, and the terminal may also be referred to by terms having the same or similar meanings.

In the disclosure, a base station is an entity that communicates with terminals and allocates resources to the terminals, and may have various forms and be referred to as a base station (BS), a Node B (NB), a next generation radio access network (NG RAN), an access point (AP), a transmission reception point (TRP), a wireless access unit, a base station controller, a node on a network, or the like. Alternatively, according to function split, the base station may be referred to as a central unit (CU) or a distributed unit (DU). However, the disclosure is not limited by the above examples, and the base station may also be referred to by terms having the same or similar meanings.

In the disclosure, the term “radio resource control (RRC) message” may be referred to as “high level information,” “high level message,” “high level signal,” “high level signaling,” “high layer signaling,” or “upper layer signaling,” and the disclosure is not limited by them and the term may also be referred to as any other term having the same or like meaning.

In the disclosure, the term “data” may be referred to as “user data,” “user plane (UP) data,” or “application data,” and may also be referred to as a term having the same or like meaning as a signal transmitted/received through a data radio bearer (DRB).

In the disclosure, a direction in which data is transmitted from a terminal may be referred to as “uplink,” and a direction in which data is transmitted to a terminal may be referred to as “downlink.” Accordingly, in the case of uplink transmission, a transmitter may refer to a terminal, and a receiver may refer to a base station or a specific network entity in a communication system, Alternatively, in the case of downlink transmission, a transmitter may refer to a base station or a specific network entity in a communication system, and a receiver may refer to a terminal.

Hereinafter, for convenience of description, objects that exchange information for the sake of access control and state management will be referred to as an NF as a whole. The NF may be, for example, at least one device from among an access and mobility management function (AMF) device, a session management function (SMF) device, and a network slice selection function (NSSF) device. However, embodiments of the disclosure may also be identically applied to a case in which the NF is actually implemented as instances (an AMF instance, an SMF instance, an NSSF instance, and the like, respectively).

In the disclosure, an instance may refer to a state in which a specific NF exists as a software code and, in order to perform functions of the NF in a physical computing system (for example, a specific computing system existing in a core network), physical and/or logical resources have been allocated from the computing system and are executable. Therefore, an AMF instance, an SMF instance, and an NSSF instance may refer to states in which physical and/or logical resources have been allocated from a specific computing system existing in a core network for the sake of AMF, SMF, and NSSF operations and are usable. Consequently, the AMF instance, SMF instance, and NSSF instance which use physical and/or logical resources allocated from a specific computing system existing in a core network for the sake of AMF, SMF, and NSSF operations may perform identical operations as in a case in which physical AMF, SMF, and NSSF devices exist.

FIG. 1 illustrates a wireless communication system according to various embodiments of the present disclosure.

Referring to FIG. 1, a radio access node (RAN) 110 and user equipment (UE) 120 are illustrated as a part of nodes using a radio channel in a wireless communication system. Although one RAN 110 and one UE 120 are illustrated in FIG. 1, other RANs identical or similar to the RAN 110 may be further included. In addition, although FIG. 1 illustrates a case in which only one UE 120 in one RAN 110 communicates, it will be obvious that multiple UEs in one RAN 110 may actually communicate.

The RAN 110 is a network infrastructure configured to provide radio access to the UE 120. The RAN 110 has a coverage (not illustrated in FIG. 1) which is a geographical area defined based on the signal transmission/reception distance. The RAN 110 may also be referred to as a base station, an access point (AP), an eNodeB (eNB), a 5th generation (5G) node, a wireless point, a transmission/reception point (TRP), or another term having an equivalent technical meaning.

The UE 120 is a device used by a user to perform communication with the RAN 110 via a radio channel. Depending on the case, the UE 120 may operate without the user's intervention. For example, the UE 120 may be a device configured to perform machine-type communication (MTC), and may not be carried by the user. The UE 120 illustrated in FIG. 1 may include at least one user-carried device and may include at least one MTC device. The UE 120 in FIG. 1 may also be referred to as a terminal, a mobile station, a subscriber station, a remote terminal, a wireless terminal, a user device, or another term having an equivalent technical meaning.

The AMF device 131 may be a network entity configured to manage radio network access and mobility regarding the UE 120. The SMF device 132 may be a network entity configured to manage connection of a packet data network for providing packet data to the UE 120. The connection between the UE 120 and the SMF 132 may be a PDU session.

The user plane function (UPF) device 133 may be a gateway configured to transfer packets transmitted/received by the UE 120, or a network entity playing a gateway role. The UPF 133 may be connected to a data network (DN) 140 connected to the Internet so as to provide a path for data transmission/reception between the UE 120 and the DN 140. Therefore, the UPF 133 may route data which is to be transferred to the Internet, among packets transmitted by the UE 120, to the Internet data network.

The network slice selection function (NSSF) device 134 may be a network entity configured to perform a network selection operation described in the disclosure, for example, a network slice selection operation. Operations of the NSSF device 134 will be described in more detail with reference to the accompanying drawings.

The authentication server function (AUSF) device 151 may be equipment (network entity) configured to provide a service for subscriber authentication.

The network exposure function (NEF) device 152 may be a network entity capable of accessing information managed by the UE 120 in the 5G network, subscribing to a mobility management event of the corresponding UE, subscribing to a session management event of the corresponding UE, requesting session-related information, configuring charging information of the corresponding UE, requesting a change in the PDU session policy regarding the corresponding UE, and transmitting a small amount of data regarding the corresponding UE.

The network repository function (NRF) device 153 may be a network entity (NF) configured to store state information of NFs and process requests for finding an accessible NF from other NFs.

The policy and charging function (PCF) device 154 may be a network entity configured to apply the service policy and charting policy of the mobile communication operator regarding the UE 120, and PDU session-related policy.

The unified data management (UDM) device 155 may be a network entity configured to store information regarding the subscriber and/or the UE 120.

The application function (AF) device 156 may be a network entity (NF) configured to provide a service to users while interworking with a mobile communication network.

The service communication proxy (SCP) device 157 is a network entity (NF) configured to provide functions such as NF discovery for communication between NFs and message transfer between NFs. The SCP 157 may operate while being integrated with the NRF 153 according to the operator's choice. In this case, the SCP 157 may include functions of the NRF 153. To the contrary, the NRF 153 may include functions of the SCP 157.

Hereinafter, for convenience of description, objects that exchange information for the sake of access control and state management will be referred to as an NF as a whole. The NF may be, for example, at least one device from among an access and mobility management function (AMF) device, a session management function (SMF) device, and a network slice selection function (NSSF) device. However, embodiments of the disclosure may also be identically applied to a case in which the NF is actually implemented as instances (an AMF instance, an SMF instance, an NSSF instance, and the like, respectively).

In the disclosure, an instance may refer to a state in which a specific NF exists as a software code and, in order to perform functions of the NF in a physical computing system (for example, a specific computing system existing in a core network), physical and/or logical resources have been allocated from the computing system and are executable. Therefore, an AMF instance, an SMF instance, and an NSSF instance may refer to states in which physical and/or logical resources have been allocated from a specific computing system existing in a core network for the sake of AMF, SMF, and NSSF operations and are usable. Consequently, the AMF instance, SMF instance, and NSSF instance which use physical and/or logical resources allocated from a specific computing system existing in a core network for the sake of AMF, SMF, and NSSF operations may perform identical operations as in a case in which physical AMF, SMF, and NSSF devices exist. Therefore, descriptions regarding the NF (AMF, SMF, UPF, NSSF, NRF, SCP, and the like) in embodiments of the disclosure may be replaced with descriptions regarding the NF instance. To the contrary, descriptions regarding the NF instance may be replaced with descriptions regarding the NF and then applied. Likewise, descriptions regarding an NW slice in embodiments of the disclosure may be replaced with descriptions regarding an NW slice instance. To the contrary, descriptions regarding the NW slice instance may be replaced with descriptions regarding the NW slice and then applied.

Although an NF of a 5G core network will be described as an example in the disclosure, this is only an example and does not limit the disclosure, and an NF, a node, or an entity may also be defined in different terminology. That is, the disclosure is not limited to a 5G communication system, and is also applicable to 6G and beyond communication systems.

In a 5G mobile communication system, a security model operates on the assumption that insiders inside the network can be trusted. This poses a risk in that, if an attacker acquires the right of a network entity (NF) or obtains a security key, for example, the attacker can freely exploit data as an inside threat actor or a malicious insider.

5G security has been designed based on a perimeter-based security architecture. For example, according to authentication and access control schemes in a 5G mobile communication system, if an NE acquires reliability through initial authentication, nodes then can approach/access mobile communication system resources. For example, in a 5G mobile communication system, an NE may acquire reliability after initial authentication and may acquire a key such that the same can be verified. Thereafter, in connection with a resource request/and/or allocation procedure, the NE may perform qualification verification based on the key, and may use a service by using resources allocated thereto.

5G mobile communication systems are designed such that an NE configured to allocate resources and/or services allocates resources and/or services if an NE configured to request resources and/or services makes a request based on a qualification verification key.

For example, authentication and security keys may be shared between NEs through 5G authentication and key agreement (AKA) and transport layer security (TLS), for example. Thereafter, the security key is used to communicate with an NE in the area which is protected by the perimeter, and which is reliable.

According to a security model in a 5G mobile communication system, if an attacker attacks an NE entitled to access the system and acquires the NE's right, or if the attacker acquires a security key (for example, authentication key), the attacker then can approach and attack the system, thereby causing a security-related issue.

5G mobile communication systems have no operations defined in connection with security control or the like regarding NEs inside the systems, and thus cannot be regarded as being based on the ZTA-based security architecture (described later). For example, analysis regarding abnormal behaviors of NEs inside the system and/or security control regarding security attacks such as approaches to the system by malicious NEs, for example, security data collection, abnormal operation analysis, vulnerability management, malicious NE blocking, and other operations are limited.

In addition, it is difficult to exchange security information between mobile network operators (MNOs) due to the absence of standardized interfaces in 5G mobile communication systems.

Zero Trust refers to a strategic approach regarding cyber security in which operations are not based on trust all the time, and all steps of interaction between respective entities during communication are continuously verified, thereby protecting the system. Zero Trust is based on the principle “never trust, always verify.” Zero Trust protects system by using strong authentication methods and utilizing network segmentation, minimum access policy, and the like.

A zero trust architecture (ZTA) may refer to a system architecture designed based on Zero Trust.

The disclosure proposes a zero trust-based security structure in a mobile communication system. The disclosure proposes a zero trust architecture-based security structure in a mobile communication system. For example, even when a UE authenticated through AKA and TLS attempts to access the core network by using a resource request or the like, an NF (for example, AMF) may request an NF for providing a service related to a security analysis according to an embodiment (for example, security analysis function (SAF)) to conduct security analysis.

According to an embodiment, an NF for security analysis may be defined/provided.

According to an embodiment, an interface, an operation, and a procedure for a security analysis service may be provided.

According to an embodiment, security data analysis based on subscription and/or request, a security analysis service and/or other security-related services may be provided. For example, an NF for providing security data analysis, a security analysis service and/or other security-related services may be provided. Although a security analysis function (SAF) will be described in the disclosure as an example of implementation of the corresponding NF, this is only an example and does not limit the disclosure, and an NF, a node, or an entity may also be defined in different terminology.

According to an embodiment, an interface for communication between the SAF and other NFs may be provided.

According to an embodiment, a security service provided by the SAF may be defined.

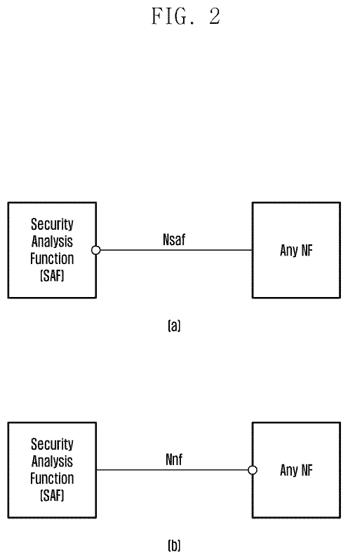

FIG. 2 illustrates an example of an SAF according to an embodiment of the disclosure.

Referring to FIG. 2 (e.g., (a) of FIG. 2), according to an embodiment, the core network may include a service-based interface (SBI) for the SAF. For example, the core network may include an Nsaf which is a service-based interface (SBI) exhibited by the SAF.

According to an embodiment, the SAF may interact with other NFs via the Nsaf. The Nsaf may be defined such that an NF requests subscription to a security-related service (or specific context related to the security-related service), cancels subscription to the security-related service (or specific context related to the security-related service), and/or request a report regarding the security-related service (or specific context related to the security-related service).

The Nsaf is only an example and does not limit the disclosure, and the SBI may be defined in different terminology. Unless specifically mentioned otherwise, another NF in the disclosure may be described as an NF other than the SAF, and may refer to any NF in the core network.

Referring to FIG. 2 (e.g., (b) of FIG. 2), according to an embodiment, the NF may interact with the SAF via the Nnf (service-based interface exhibited by NF). The Nnf may be defined such that the SAF request subscription to vulnerability-related information (or specific context related to the vulnerability-related information), cancels subscription to the vulnerability-related information (or specific context related to the vulnerability-related information), and/or request a report regarding the vulnerability-related information (or specific context related to the vulnerability-related information). FIG. 2 (e.g., (b) id FIG. 2) may be understood as an example of a vulnerability data collection architecture according to an embodiment.

Although the SAF is illustrated in FIG. 2 as interacting with one NF, this is only an example and does not limit the disclosure, and the SAF may interact with multiple NFs. In addition, although the SAF is illustrated in FIG. 2 as interacting with an NF, this is only an example, and the SAF may interact with nodes other than the NF, for example, with one or more UEs and/or one or more base stations. For example, the SAF may interact with a UE or a base station via an NF (for example, via an AMF). Therefore, an NF in the disclosure may be replaced with a UE, a base station, and/or other nodes/entities.

According to an embodiment, the SAF may provide subscription or request-based security data analysis, analytics information, a security analysis service and/or other security services (hereinafter, referred to as security-related services) to other NFs (via the Nsaf). For example, security-related services that the SAF can provide may include provision of vulnerability-related information, information regarding vulnerable NEs, and the like, but are not limited thereto.

According to an embodiment, the SAF may provide services (or provide services through the Nsaf) as in Table 1 below. The service names in Table 1 are exemplary, and other names may also be used as service names.

TABLE 1

| Service Name | Service Operations | Operation Semantics |
|---|---|---|
| Nsaf_SecurityAnalyt- | Subscribe | Subscribe/Notify |
| icsSubscription | Unsubscribe | |
| | Notify | |
| Nsaf_SecurityAnalyticsInfo | Request | Request/Response |

According to an embodiment, an NF may request the SAF to provide a security-related service (via the Nsaf). The security-related service requested by the NF and/or provided by the SAF may be a subscription-based security-related service and/or a one-time request-based security-related service.

According to an embodiment, in the case of the subscription-based security-related service, the NF that requested subscription may become a subscriber and receive the security-related service from the SAF until the subscription is canceled (via the Nsaf) since the request for the security-related service.

According to an embodiment, in the case of the one-time request-based security-related service, the SAF may provide the security-related service (via the Nsaf) once to the NF that requested the one-time request-based security-related service. For example, the request for the one-time security-related service may include a request for one or more services among multiple services that the SAF can provide, and the SAF may provide one or more services that the NF requested.

According to an embodiment, the NF may be provided with the one-time request-based security-related service even while being provided with the subscription-based security-related service.

For example, the NF may make a one-time request for one or more services other than one or more services provided through the subscription-based security-related service. The SAF may provide the one-time requested one or more services together to the NF currently provided with the subscription-based security-related service.

As another example, the NF may make a one-time request for at least one of one or more services provided through the subscription-based security-related service, and the SAF may provide the one-time requested service to the NF. After the one-time requested service is provided, the NF may be continuously provided with one or more services through the subscription-based security-related service. This is only an example, and the subscription-based security-related service and the one-time request-based security-related service may be provided separately in the disclosure.

According to an embodiment, the SAF may collect/acquire vulnerability-related information from other NFs (via the Nnf). For example, the SAF may collect/acquire specific context from other NFs (via the Nnf). For example, the SAF may provide a security-related service, based on the vulnerability-related information. In the disclosure, the vulnerability-related information may be used interchangeably with other terms such as security information.

According to an embodiment, the SAF may collect vulnerability-related information, based on subscription and/or based on a one-time request. According to an embodiment, the NF that received a request from the SAF may transfer vulnerability-related information to the SAF.

According to an embodiment, in the subscription-based case, that SAF that requested subscription-based vulnerability-related information may become a subscriber and receive vulnerability-related information provided by the NF until the request is released/canceled (for example, until the subscription is released/canceled) (via the Nnf) since the request for subscription-based vulnerability-related information. For example, the SAF may be provided with vulnerability-related information during subscription. For example, the timepoint at which the subscribed SAF is provided with vulnerability-related information may be configured/determined by an event reporting mode (# of report, periodic/non periodic reporting), the maximum number of reports, the maximum duration of reporting etc. For more details, following descriptions of an embodiment regarding security service subscription may be referred to, and at least a part of the embodiment regarding security service subscription may be applied to an embodiment regarding vulnerability-related information provision.

According to an embodiment, in the one-time request-based case, the SAF may request the NF to provide one-time vulnerability-related information, and may receive one-time vulnerability-related information provided by the NF. For example, the request for a one-time security-related service may include a request for at least a part of information that the NF can provide, and the SAF may receive the requested information regarding at least a part from the NF.

According to an embodiment, the SAF may be provided with one-time request-based vulnerability-related information even while being provided with subscription-based vulnerability-related information.

For example, the SAF may make a one-time request for information other than information currently provided through subscription-based vulnerability-related information, and the SAF may be provided with the one-time requested vulnerability-related information together while being provided with subscription-based vulnerability-related information.

As another example, the SAF may make a one-time request for at least a part of information currently provided through subscription-based vulnerability-related information, and the SAF may receive the one-time requested information provided by the NF. After the one-time requested service is provided, the SAF may be continuously provided with information through subscription-based vulnerability-related information. This is only an example, and the subscription-based vulnerability-related information and the one-time request-based vulnerability-related information may be provided separately in the disclosure.

According to an embodiment, the SAF may analyze provided vulnerability-related information and may provide a security-related service based on the result of analysis.

According to an embodiment, the SAF may collect vulnerability-related information before, while, or after receiving a request for a security-related service. That is, the SAF may collect vulnerability-related information regardless of whether a request for a security-related service is received. Upon receiving a request for a security-related service, the security-related service may be provided based on the collected vulnerability-related information.

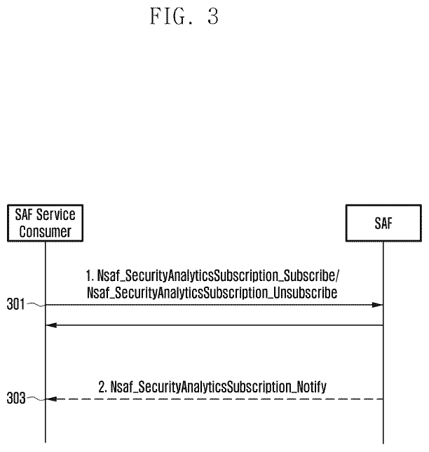

FIG. 3 illustrates an example of a procedure related to security analytics service subscription according to an embodiment of the present disclosure.

FIG. 3 illustrates an example of a procedure in which an SAF service consumer subscribes to/unsubscribes from security analytics (security analytics subscribe/unsubscribe by SAF service consumer). Message names are exemplary, and other message names may also be used.

FIG. 3 illustrates an example of a procedure used by an SAF service consumer (for example, including an NF) consumer to subscribe/unsubscribe to be notified of security analytics information, by using analytics information (for example, Nsaf_SecurityAnalyticsSubscription service) provided by the SAF. In addition, this procedure may also be used by the SAF service consumer to modify existing security analytics subscription.

Referring to FIG. 3, in operation 301 according to an embodiment, the SAF service consumer may transmit/invoke a subscription request message or a unsubscription message in order to subscribe to or unsubscribe from a security-related service (for example, security analytics information). For example, the SAF service consumer may transmit/invoke a Nsaf_SecurityAnalyticsSubscription_Subscribe so as to subscribe to a security-related service (for example, security analytics information). In addition, the SAF service consumer may transmit/invoke a Nsaf_SecurityAnalyticsSubscription_Unsubscribe so as to unsubscribe.

According to an embodiment, upon receiving a message requesting service subscription (for example, security analytics information subscription) from the SAF service consumer, the SAF may determine whether new vulnerability-related information collection is necessary. The SAF may provide a subscription-based security-related service to the SAF service consumer. In the disclosure, new vulnerability-related information (or new security information) may refer to information other than the information (independently) held by the SAF (for example, stored in a database inside the SAF). If new vulnerability-related information is necessary, the SAF may inquire/request other NFs and/or other NEs in the communication system (for example, base stations and/or UEs, other NEs) about the necessary information. The SAF may provide the requested service to the SAF service consumer, based on information received from other NFs and/or other NEs. If new vulnerability-related information is unnecessary, the SAF may provide the requested service to the SAF service consumer, based on information held thereby.

In operation 303 according to an embodiment, if the SAF service consumer has subscribed to a service (for example, security analytics information), the SAF may provide/notify of the service (for example, security analytics information) to the SAF service consumer at the request of the SAF service consumer. For example, if the SAF service consumer has subscribed to a service (for example, security analytics information), the SAF may notify of the service (for example, security analytics information) through a Nsaf_SecurityAnalyticsSubscription_Notify service operation at the request of the SAF service consumer. For example, the request of the SAF service consumer may be included in a Nsaf_SecurityAnalyticsSubscription_Subscribe, but is not limited thereto. The SAF may provide analytics information through the Nsaf_SecurityAnalyticsSubscription_Notify at the request of the SAF service consumer.

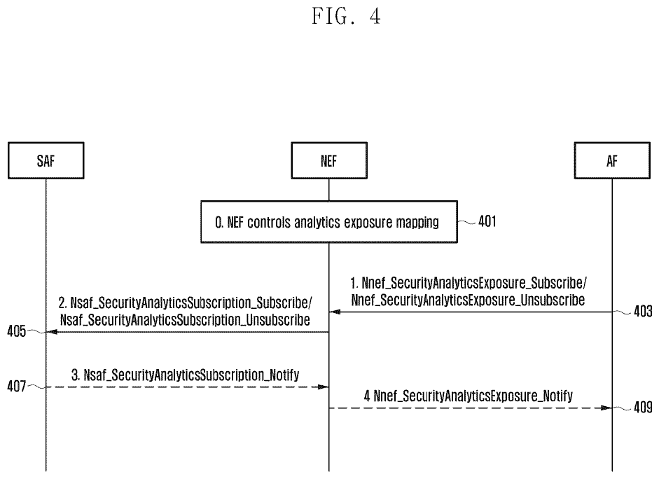

FIG. 4 illustrates an example of a procedure related to security analysis service subscription according to an embodiment of the present disclosure.

FIG. 4 illustrates an example of a procedure in which an application function (AF) subscribes to/unsubscribes from security analytics (analytics subscribe/unsubscribe by AF). Message names are exemplary, and other message names may also be used. FIG. 3 may be understood as an exemplary case in which the SAF service consumer is not an AF, and FIG. 4 may be understood as an exemplary case in which the SAF service consumer is an AF.

Referring to FIG. 4, according to an embodiment, the interaction between the AF and the SAF may be performed via a network exposure function (NEF). The AF may subscribe to/unsubscribe from a service (for example, security analytics) via the NEF. Security analytics exposure to the AF may be performed via the NEF by using subscription regarding the SAF. That is, the AF may subscribe to/unsubscribe from a service (for example, security analytics information) with regard to the SAF via the NEF.

In operation 401 according to an embodiment, the NEF may control analytics exposure mapping. The NEF may control the service (for example, security analytics information and/or analytics content) provided to the AF by the SAF through exposure mapping. The NEF may restrict/determine a service that can be exposed to the AF, that is, a service that can be provided to the AF, among services provided by the SAF through analytics exposure mapping.

For example, if a parameter and/or parameter value requested by the AF observes an inbound restriction of analytics exposure mapping, the NEF may transfer the parameter and/or parameter value requested by the AF to the SAF.

For example, if the AF's request does not observe the restriction of analytics exposure mapping, the NEF may apply a restriction regarding the subscription request regarding the SAF. For example, the NEF may not transfer the parameter and/or parameter value requested by the AF to the SAF.

In operation 403 according to an embodiment, the AF may transmit/invoke a subscription request message or a unsubscription message in order to subscribe to or unsubscribe from a security-related service (for example, security analytics information) via the NEF. For example, the AF may transmit/invoke a Nnef_Security AnalyticsExposure_Subscribe so as to subscribe to a security-related service (for example, security analytics information). In addition, the AF may transmit/invoke a Nnef_Security AnalyticsExposure_Unsubscribe so as to unsubscribe.

That is, the AF may transmit/invoke a Nnef_Security AnalyticsExposure_Subscribe or Nnef_Security AnalyticsExposure_Unsubscribe service operation so as to subscribe to or unsubscribe from security analytics information via the NEF.

In operation 405 according to an embodiment, based on a request of the AF, the NEF may transmit/invoke a subscription request message or a unsubscription message in order to subscribe to or unsubscribe from a security-related service (for example, security analytics information). For example, the NEF may transmit/invoke a Nsaf_SecurityAnalyticsSubscription_Subscribe so as to subscribe to a security-related service (for example, security analytics information). In addition, the NEF may transmit/invoke a Nsaf_SecurityAnalyticsSubscription_Unsubscribe so as to unsubscribe.

That is, at the request of the AF, the NEF may transmit/invoke a Nsaf_SecurityAnalyticsSubscription_Subscribe or Nsaf_SecurityAnalyticsSubscription_Unsubscribe service operation so as to subscribe to or unsubscribe from a security-related service (for example, security analytics information). The NEF may record the AF's request information.

In operation 407 according to an embodiment, if the NEF has subscribed to a service (for example, security analytics information), the SAF may provide/notify of a service (for example, security analytics information) at the request of the NEF. For example, the SAF may transmit/invoke a Nsaf_SecurityAnalyticsSubscription_Notify service operation so as to notify of a service (for example, security analytics information).

That is, if the NEF has subscribed to a service (for example, security analytics information), the SAF may transmit/invoke a Nsaf_SecurityAnalyticsSubscription_Notify service operation so as to inform the NEF of the service (for example, security analytics information) or (subscription-related) termination request.

In operation 409 according to an embodiment, the NEF may transfer the service (for example, security analytics information) to the AF. For example, the NEF may transmit/invoke a Nnef_SecurityAnalyticsExposure_Notify service operation so as to transfer the service (for example, security analytics information) to the AF. In this case, the NEF may apply an outbound restriction based on analytics exposure mapping, thereby restricting the parameter and/or parameter value of Nnef_SecurityAnalyticsExposure_Notify.

That is, upon receiving the Nsaf_SecurityAnalyticsSubscription_Notify from the SAF, the NEF may transmit/invoke a Nnef_SecurityAnalyticsExposure_Notify service operation so as to notify the AF of the service (for example, security analytics information) or termination request. The NEF may then apply an outbound restriction to the Nnef_SecurityAnalyticsExposure_Notify regarding the AF. For example, the parameter and/or parameter value of the Nnef_SecurityAnalyticsExposure_Notify service operation may be restricted.

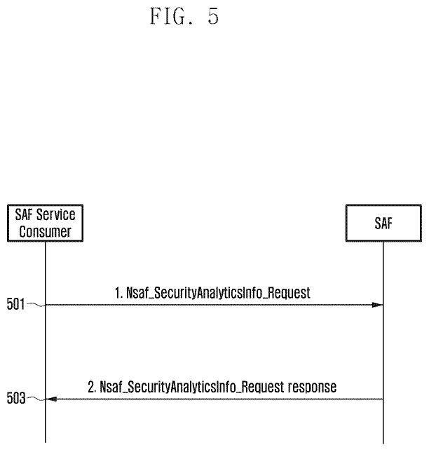

FIG. 5 illustrates an example of a security analysis request procedure according to an embodiment of the present disclosure. FIG. 5 illustrates an example of a procedure in which an SAF service consumer requests security analysis. Message names are exemplary, and other message names may also be used.

FIG. 5 illustrates an example of a procedure used by an SAF service consumer (for example, including an NF) to request and then receive security analytics information by using security analytics information (for example, Nsaf_SecurityAnalyticsInfo service) provided by the SAF.

Referring to FIG. 5, in operation 501 according to an embodiment, the SAF service consumer may transmit/invoke a message so as to request a security-related service (for example, security analytics information). For example, the SAF service consumer may transmit/invoke a Nsaf_SecurityAnalyticsInfo_Request service operation so as to request a security-related service (for example, security analytics information).

According to an embodiment, if there is a request for a service (for example, security analytics information) from the SAF service consumer, the SAF may determine whether new vulnerability-related information collection is necessary. In the disclosure, new vulnerability-related information (or new security information) may refer to information other than the information (independently) held by the SAF (for example, stored in a database inside the SAF). If new vulnerability-related information is necessary, the SAF may inquire/request other NFs and/or other NEs in the communication system (for example, base stations and/or UEs, other NEs) about the necessary information. The SAF may provide the requested service to the SAF service consumer, based on information received from other NFs and/or other NEs. If new vulnerability-related information is unnecessary, the SAF may provide the requested service to the SAF service consumer, based on information held thereby.

In operation 503 according to an embodiment, the SAF may provide a service to the SAF service consumer, for example, may reply by security analytics information. For example, the SAF may transmit a Nsaf_ Security AnalyticsInfo_Request response including security analytics information to the SAF service consumer.

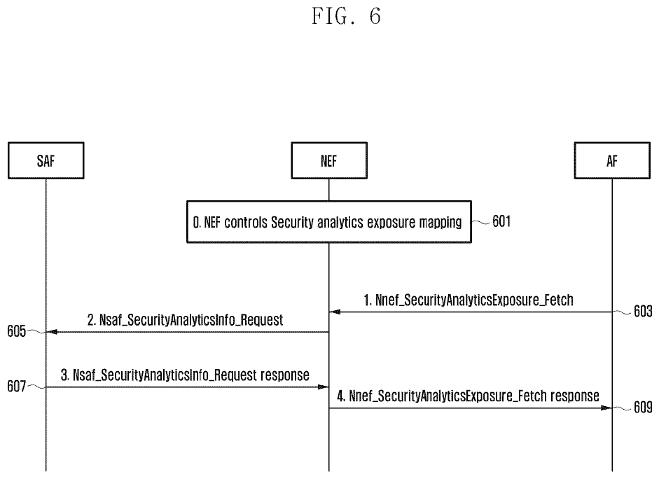

FIG. 6 illustrates an example of a security analysis request procedure according to an embodiment of the present disclosure.

FIG. 6 illustrates an example of a procedure in which an AF requests security analysis. Message names are exemplary, and other message names may also be used. FIG. 5 may be understood as an exemplary case in which the SAF service consumer is not an AF, and FIG. 6 may be understood as an exemplary case in which the SAF service consumer is an AF.

Referring to FIG. 6, according to an embodiment, the interaction between the AF and the SAF may be performed via an NEF. The AF may make a request regarding a service (for example, security analytics) via the NEF. Security analytics exposure to the AF may be performed via the NEF by using a security analytics request regarding the SAF. That is, the AF may request a service (for example, security analytics information) with regard to the SAF via the NEF, and may be provided therewith.

In operation 601 according to an embodiment, the NEF may control analytics exposure mapping. The NEF may control the service (for example, security analytics information and/or analytics content) provided to the AF by the SAF through exposure mapping. The NEF may restrict/determine a service that can be exposed to the AF, that is, a service that can be provided to the AF, among services provided by the SAF through analytics exposure mapping.

For example, if a parameter and/or parameter value requested by the AF observes an inbound restriction of analytics exposure mapping, the NEF may transfer the parameter and/or parameter value requested by the AF to the SAF.

For example, if the AF's request does not observe the restriction of analytics exposure mapping, the NEF may apply a restriction regarding the request regarding the SAF. For example, the NEF may not transfer the parameter and/or parameter value requested by the AF to the SAF.

In operation 603 according to an embodiment, the AF may transmit/invoke a request message in order to request a security-related service (for example, security analytics information) via the NEF. For example, the AF may transmit/invoke a Nnef_Security AnalyticsExposure_Fetch so as to request a security-related service (for example, security analytics information).

That is, the AF may transmit/invoke a Nnef_SecurityAnalyticsExposure_Fetch service operation so as to request security analytics information via the NEF.

In operation 605 according to an embodiment, based on a request of the AF, the NEF may transmit/invoke a request message in order to request a security-related service (for example, security analytics information). For example, the NEF may transmit/invoke a Nsaf_SecurityAnalyticsInfo_Request so as to request a security-related service (for example, security analytics information). That is, at the request of the AF, the NEF may transmit/invoke a Nnsaf_AnalyticsInfo_Request service operation so as to request a security-related service (for example, security analytics information). The NEF may record the AF's request information.

In operation 607 according to an embodiment, the SAF may provide/notify of a service (for example, security analytics information) at the request of the NEF. For example, the SAF may transmit/invoke a Nnsaf_AnalyticsInfo_Request response service operation so as to notify of a service (for example, security analytics information). That is, the SAF may respond to the NEF by security analytics information through a Nsaf_SecurityAnalyticsInfo_Request response.

In operation 609 according to an embodiment, the NEF may transfer the service (for example, security analytics information) to the AF. For example, the NEF may transmit/invoke a Nnef_SecurityAnalyticsExposure_Fetch response service operation so as to transfer the service (for example, security analytics information) to the AF. In this case, the NEF may apply an outbound restriction based on analytics exposure mapping, thereby restricting the parameter and/or parameter value of the Nnef_SecurityAnalyticsExposure_Fetch response.

According to an embodiment, the subscription request message and/or request message may include at least one of parameters in Table 2 and Table 3. Table 2 enumerates an example of parameters related to identities for the subscription request message and/or request message. Table 3 enumerates an example of parameters related to reporting information for the subscription request message and/or request message. For example, Nsaf_SecurityAnalyticsSubscription_Subscribe and/or Nsaf_SecurityAnalyticsInfo_Request may include as least some of the parameters in Table 2 and Table 3.

TABLE 2
A list of Security Analytics ID(s): identifies the requested security analytics.
Security level information (information regarding the security level regarding
objects), vulnerability information, Security experience (information regarding
security experience, for example, information regarding security-related cases at a
past and/or previous timepoint), abnormal behavior (information regarding abnormal
operations. For example, a case in which operations such as message
transmission/reception deviate (substantially) from the average) and/or other security
related information
Target of Security Analytics Reporting: indicates the object(s) for which Security
Analytics information is requested, entities such as specific UEs/NEs, a group of
UE/NE(s) or any UE/NE (i.e., all UE/NEs).
A Notification Target Address. For example, this may be included for
Nsaf_SecurityAnalyticsSubscription_Subscribe, but is not limited thereto.
Security Subscription Correlation ID: identifies an existing analytics security
subscription that is to be modified. For example, this may be included for
Nsaf_SecurityAnalyticsSubscription_Subscribe, but is not limited thereto.
Information of previous security analytics subscription. When setting up the security
analytics generation, this information may be used to retrieve analytics context from
the previous SAF in order to build upon the context that is already related to this
subscription. For example, this may be included for
Nsaf_SecurityAnalyticsSubscription_Subscribe, but is not limited thereto.
The Notification Correlation Information: The Correlation information in input data
which helps SAF correlate data from different NFs, OAM and/or UE application(s).
For example, this may be included for Nsaf_Security AnalyticsSubscription_Notify,
but is not limited thereto.

TABLE 3
Vulnerability information
Security Analytics Reporting Parameters. For example, this may be included
for Nsaf_SecurityAnalyticsSubscription_Subscribe, but is not limited thereto.
Event reporting mode(# of report, periodic/non periodic reporting),
Maximum number of reports, Maximum duration of reporting and etc.
Reporting Thresholds, which indicate conditions on the level of each
requested security analytics that when reached may be notified by the SAF.
For example, this may be included for
Nsaf_SecurityAnalyticsSubscription_Subscribe, but is not limited thereto.
Preferred level of accuracy of the security analytics (e.g., “Low,” “Medium,”
“High” or “Highest”; 0~Max number(ex, 10)).
Dataset Statistical Properties: information in order to influence the data
selection mechanisms to be used for the generation of a Security Analytics ID,
assuring that the generated Security Analytics ID reflects the statistical
characteristics of the data that are relevant for the SAF consumer. The
following dataset statistical properties are allowed:
Uniformly distributed datasets, which indicates the use of data samples that
are uniformly distributed according to the different aspects of the requested
analytics (e.g., equivalent data samples for each UE listed as a Target of
Analytics Reporting or for S-NSSAIs included in the Analytics Filter
Information).
Datasets with or without outliers, which indicates that the data samples may
consider or disregard data samples that are at the extreme boundaries of the
value range.
Security Analytics target period: time interval [start . . . end], either in the past
(both start time and end time in the past) or in the future (both start time and
end time in the future). The time interval is expressed with actual start time
and actual end time (e.g., via UTC time). When the Security Analytics
Reporting Parameters indicate a periodic reporting mode, the time interval can
also be expressed as positive or negative offsets to the reporting time, which
indicates a subscription for predictions or statistics respectively. By setting
start time and end time to the same value, the consumer of the security
analytics can request security analytics or subscribe to security analytics for a
specific time rather than for a time interval.
Data time window: if specified, only events that have been created in the
specified time interval are considered for the security analytics generation.
Time when analytics information is needed (if applicable): indicates to the
SAF the latest time the security analytics consumer expects to receive security
analytics data provided by the SAF. If the time is reached the consumer does
not need to wait for the security analytics information any longer, yet the SAF
may send an error response or error notification to the consumer. “Time when
analytics information is needed” is a relative time interval as the gap with
respect to security analytics request/subscription (e.g., “in 10 minutes”).

According to an embodiment, the SAF may perform operations corresponding to one or more parameters included in a received subscription request message and/or request message. Hereinafter, some exemplary operations will be described.

Upon receiving a security analytics ID's list parameter, the SAF may identify the requested security analytics and/or security analysis service based on the security analytics ID's list, and may provide the requested security analytics and/or security analysis service.

Upon receiving a security analytics reporting target parameter, the SAF may identify the object regarding which security analytics and/or security analysis service has been requested, and may provide security analytics and/or security analysis service regarding the object. That is, the security analytics reporting target parameter may be an analysis request regarding a specific object. The specific object may be one or more nodes, a specific group including one or more nodes, and/or any node. For example, the specific object may be one or more UEs, a group including one or more UEs, and/or all UEs that accessed the core network.

Upon receiving a notification target address parameter, the SAF may identify the node to be provided with security analytics and/or security analysis service. That is, the node that transmitted a subscription request message and/or request message to the SAF and the node that receives security analytics and/or security analysis service provided by the SAF may be identical to or different from each other, and this may be identified based on the notification target address parameter.

For example, if no notification target address parameter is included, the SAF may identify that the node that transmitted a subscription request message and/or request message is the node to be provided with security analytics and/or security analysis service. That is, if a node wants to be provided with security analytics and/or security analysis service, the node may include no notification target address parameter in the subscription request message and/or request message. As another example, if a node wants to be provided with security analytics and/or security analysis service, the node may include a notification target address parameter which indicates the node in the subscription request message and/or request message.

Upon receiving a security subscription correlation ID parameter, the SAF may identify modification regarding existing security analytics subscription. That is, the security subscription correlation ID parameter may indicate modification regarding corresponding security analytics subscription. For example, an analysis target UE or a security analysis ID may be added through the security subscription correlation ID, but the disclosure is not limited thereto.

Upon receiving a previous security analytics subscription information parameter, the SAF may generate security analytics and/or security analysis service with reference to previous security analytics and/or security analysis service. That is, the previous security analytics subscription information may indicate that one or more security analytics and/or security analysis service related to security analytics subscription prior to the current security analytics subscription are related to one or more security analytics and/or security analysis service for the current security analytics subscription. Upon receiving a security analytics reporting parameter, the SAF may provide security analytics and/or security analysis service, based on the security analytics reporting parameter. For example, if the number of reporting is indicated, the SAF may provide security analytics and/or security analysis service as many as the indicated number of reporting. For example, if periodic/non-periodic reporting is indicted, the SAF may provide security analytics and/or security analysis service periodically/non-periodically as indicated. For example, if the maximum number of reporting is indicated, the SAF may provide security analytics and/or security analysis service as many as the indicated number of reporting or less. For example, if the maximum interval is indicated, the SAF may provide security analytics and/or security analysis service during the time within the indicated maximum interval.

Upon receiving a reporting threshold parameter, the SAF may determine, based on the reporting threshold, whether to provide security analytics and/or security analysis service. The reporting threshold parameter may indicate a condition related to each requested security analytics. If the reporting threshold is reached, the SAF may provide security analytics and/or security analysis service. The reporting threshold may be utilized differently depending on the type/object of the requested security analytics. For example, if the reporting threshold is associated with a CVSS, a CVSS may be reported above/below a specific threshold (corresponding to the reporting threshold). For example, if security level information is requested, the SAF may provide security analytics information if the security level is above/below a specific threshold (corresponding to the reporting threshold).

Upon receiving a parameter regarding the preferred level of accuracy of security analytics, the SAF may provide security analytics and/or security analysis service satisfying the preferred level of accuracy. Upon receiving a dataset statistical property parameter, the SAF may provide security analytics and/or security analysis service and may provide information regarding data used for generation of the security analytics and/or security analysis service and/or for data analysis for the security analytics and/or security analysis service.

Upon receiving a security analytics target interval parameter, the SAF may perform data analysis for security analytics and/or security analysis service during the security analytics target interval. Upon receiving a data target window parameter, the SAF may at least consider data inside the data target window in connection with data analysis for security analytics and/or security analysis service. For example, the data target window may be included in the security analytics target interval parameter.

Upon receiving a parameter regarding the time when security analytics information is needed, the SAF may identify until when a node needs security analytics information, and may provide security analytics and/or security analysis service within the identified time.

According to an embodiment, vulnerability-related information or vulnerability information may include at least one of parameters in Table 4 below:

TABLE 4
NEs: a list of NEs on known vulnerabilities
UEs: a list of UEs on known vulnerabilities
NFs: a list of NFs on known vulnerabilities
ANs: a list of ANs on known vulnerabilities (AN: base station)
Common vulnerabilities and exposures (CVEs): a list of publicly disclosed
information security vulnerabilities and exposures.
Common vulnerability scoring system (CVSS): a set of open standards for
assigning a number to a vulnerability to assess its severity.
CVE numbering authorities (CNAs): organizations that identify and
distribute CVE ID numbers to researchers and vendors for inclusion
in public announcements of new vulnerabilities.
Common weakness enumeration (CWE): a community-developed list of
software and hardware weakness types
Vendors: a list of vendors on known vulnerabilities
Products: a list of product on known vulnerabilities
Versions: a list of version on known vulnerabilities

In Table 4, vendors, products, and versions may be combined and used to indicate a specific version of a specific product provided/manufactured by a specific vendor. For example, a specific version of a specific terminal manufactured by a specific vendor may be indicated, or the version of specific software manufactured by a specific vendor may be indicated.

According to an embodiment, the SAF may collect at least one of the parameters in Table 4, and may provide security analytics information and/or security analysis service, based on at least one of the parameters in Table 4. For example, the SAF may analyze at least one of the parameters in Table 4 and may provide the result of analysis. The SAF may refer to correlation information in connection with performing analysis. An NF, a UE, or operations and management (OAM) may generate various pieces of information, and the correlation information may be used to recognize the correlation between such various pieces of information. Table 5 below may be referred to as an example of the correlation information.

TABLE 5

| Correlation Information | Description |
|---|---|
| Timestamp, IP address 5-tuple | To correlate the data from AF and from |
| | UPF. |
| Timestamp, AN Tunnel Info | To correlate the UPF data and OAM data |
| | which are reported by the RAN |
| Timestamp, UE IP address | To correlate the data from UPF and SMF. |
| Timestamp, SUPI | To correlate data from SMF and AMF. |
| Timestamp, SUPI, DNN, S- | To correlate data from SMF and PCF. |
| NSSAI or UE IP address | |
| Timestamp, RAN UE NGAP | To correlate the AMF data and OAM data |
| ID and Global RAN Node ID | reported by the RAN |
| Timestamp, Application ID, | To correlate data from SMF and AF. |
| IP filter information | |
| Timestamp, UE ID or UE IP | To correlate data from 6GC NF (e.g., |
| address, Application ID, | SMF, UPF) and UE Application (via the |
| DNN, S-NSSAI | AF). |

* IP: internet protocol
* AN: Access Network
* SUPI: Subscription Permanent Identifier
* DNN: Data Network Name
* S-NSSAI: Single Network Slice Selection Assistance Information
* RAN: Radio Access Network
* NGAP: NG Application Protocol
* A time stamp associated with the collected information. The SAF may collect/acquire information from other NFs and/or NEs in connection with performing security analytics. The timestamp may indicate the time at which collected/acquired information is generated in the corresponding NF and/or NE.

According to an embodiment, a response (service-providing message) provided by the SAF may include at least one of parameters in Table 6. Table 6 may enumerate an example of parameters related to time information and/or confidence information for the SAF's response.

For example, Nsaf_SecurityAnalyticsSubscription_Notify and/or Nsaf_SecurityAnalyticsInfo_Request response may include at least some parameters in Table 6.

TABLE 6
Timestamp of security analytics generation: allows consumers to decide until when
the received information may be used. For instance, an NF can deem a received
notification from SAF for a given feedback as invalid based on this timestamp
Validity period: defines the time period or the time duration for which the security
analytics information is valid.
Confidence: probability assertion: i.e., confidence in the security analysis. (e.g.,
“Low,” “Medium,” “High” or “Highest”; 0~Max number(ex, 10))
For each Security Analytics ID, the Termination Request: notifies the consumer that
the subscription is requested to be cancelled as the SAF can no longer serve this
subscription.
Revised waiting time: indicates to the consumer a revised waiting value for “Time
when security analytics information is needed.” For example, this may be included
for an error response and/or an error notification, but is not limited thereto.

According to an embodiment, the NF may perform operations corresponding to one or more parameters included in the received response. Hereinafter, some exemplary operations will be described.

The parameter regarding the timestamp of security analytics generation may be related to the time at which the SAF generated security analytics information. Upon receiving the parameter regarding the timestamp of security analytics generation, the NF may determine, based on the timestamp, until when the provided security analytics information and/or security analysis service can be used, and/or until when the same is to be identified as valid.

The valid period parameter may be related to the period of time during which the security analytics information and/or security analysis service is valid. Upon receiving the valid period parameter, the NF may determine, based on the valid period, the period of time during which the provided security analytics information and/or security analysis service is valid. For example, if provided together with the timestamp parameter, the starting timepoint of the valid time period may be determined based on the timestamp parameter, and the security analytics information and/or security analysis service may be deemed to be valid during the valid time period from the starting timepoint.

The confidence parameter may indicate the degree of confidence in the security analytics information and/or security analysis service. For example, if the confidence parameter is below a specific threshold, the NF may ignore the same. As another example, even if the confidence parameter is below a specific threshold, the NF may perform an additional operation for reinforcing security if information corresponding to the confidence parameter indicates a security-related risk (for example, indicates that security is vulnerable).

The termination request parameter may be configured with regard to each security analytics ID, and may be used to request termination of the corresponding security analytics information and/or security analysis service. Upon receiving the termination request parameter, the NF may terminate subscription regarding (that is, unsubscribe from) the corresponding security analytics and/or security analysis service.

The revised waiting time parameter may indicate a revised waiting value regarding the time when security analytics information is needed. For example, if an error occurs in relation to security analytics information and/or security analysis service provision, and with regard to a parameter regarding the time when security analytics information is necessary received from the NF, the SAF may transmit a revised waiting time parameter indicating a modified time regarding the necessary time to the NF. Upon receiving this, the NF may await security analytics information and/or security analysis service provision from the SAF until the modified waiting time.

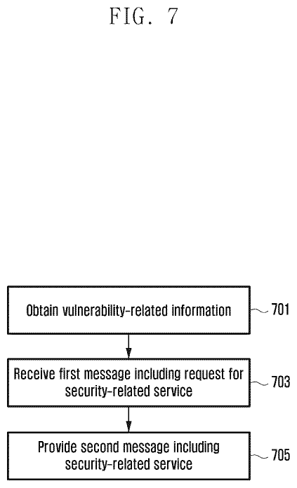

FIG. 7 illustrates an example of operations of a first node according to an embodiment of the present disclosure. The method in FIG. 7 is exemplary, and the method illustrated in the flowchart of FIG. 7 may be variously modified. For example, although illustrated as a series of steps, various steps in respective drawings may overlap, occur in parallel, occur in different orders, or occur multiple times. In another example, a step may be omitted or replaced with another step. In FIG. 7, the first node may be the SAF according to an embodiment described above.

Referring to FIG. 7, in operation 701 according to an embodiment, the first node may obtain vulnerability-related information from one or more nodes among multiple nodes included in the communication system. For example, the first node may obtain vulnerability-related information from one or more nodes among multiple nodes via an Nnf interface.

In operation 703 according to an embodiment, the first node may receive a first message including a request for a security-related service from a second node. For example, the second node may be included or may not be included in one or more nodes that provided vulnerability-related information. For example, the first node may receive a first message from the second node via an Nsaf interface. For example, the first message may be a subscription request message and/or a (one-time) request message.

In operation 705 according to an embodiment, after receiving a request for a security-related service, the first node may provide a second message including a security-related service, based on vulnerability-related information. For example, the first node may provide a second message through an Nsaf interface, and the node that receives the second message may be identical or different from the second node.

Above descriptions of an embodiment may be referred to for more details of the operation of the first node illustrated in FIG. 7.

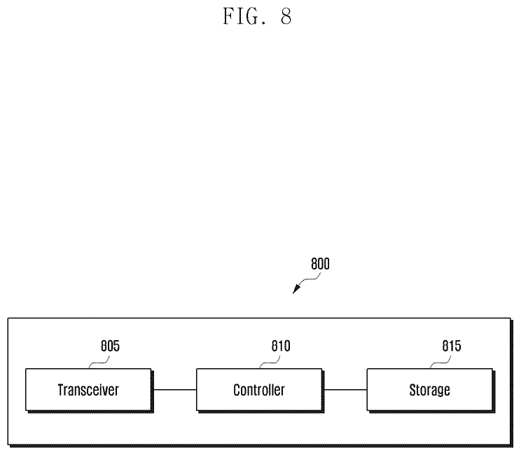

FIG. 8 illustrates an example of the structure of a node according to an embodiment of the present disclosure. FIG. 8 may illustrate the SAF or NF according to an embodiment described above.

Referring to FIG. 8, the node 800 according to an embodiment of the disclosure may include a transceiver 805, a controller 810, and a storage 815. In the disclosure, the controller 810 of the node 800 may be defined as a circuit or an application-specific integrated circuit or at least one processor.

The transceiver 805 may transmit/receive signals. The transceiver 805 may transmit signals to a UE, a base station, or another node according to an embodiment of the disclosure, for example, and may receive signal from a UE, a base station, or another node.

The controller 810 may control overall operations of the node 800 according to an embodiment provided in the disclosure. For example, the controller 810 may control signal flows between respective blocks so as to perform operations according to the above-described drawings (or flowcharts).

The storage 815 may store at least one of information transmitted/received via the transceiver 805 and information generated via the controller 810.

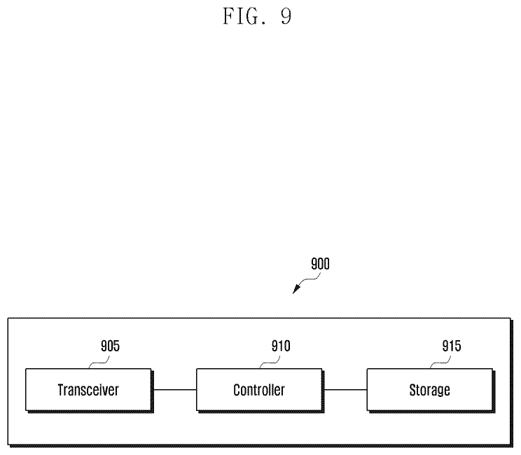

FIG. 9 illustrates an example of the structure of a UE according to an embodiment of the present disclosure.

Referring to FIG. 9, the UE 900 according to an embodiment of the disclosure may include a transceiver 905, a controller 910, and a storage 915. In the disclosure, the controller 910 of the UE 900 may be defined as a circuit or an application-specific integrated circuit or at least one processor.

The transceiver 905 may transmit/receive signals. The transceiver 905 may transmit signals to a node or a base station according to an embodiment of the disclosure, for example, and may receive signal from the node or base station.

The controller 910 may control overall operations of the UE 900 according to an embodiment provided in the disclosure. For example, the controller 910 may control signal flows between respective blocks so as to perform operations according to the above-described drawings (or flowcharts).

The storage 915 may store at least one of information transmitted/received via the transceiver 905 and information generated via the controller 910.

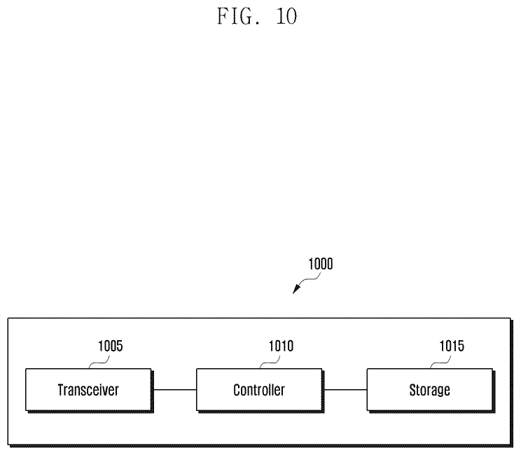

FIG. 10 illustrates an example of the structure of a base station according to an embodiment of the present disclosure.

Referring to FIG. 10, the base station 1000 according to an embodiment of the disclosure may include a transceiver 1005, a controller 1010, and a storage 1015. In the disclosure, the controller 1010 of the base station 1000 may be defined as a circuit or an application-specific integrated circuit or at least one processor.

The transceiver 1005 may transmit/receive signals. The transceiver 1005 may transmit signals to a UE or a node according to an embodiment of the disclosure, for example, and may receive signal from the UE or node.

The controller 1010 may control overall operations of the node 1000 according to an embodiment provided in the disclosure. For example, the controller 1010 may control signal flows between respective blocks so as to perform operations according to the above-described drawings (or flowcharts).

The storage 1015 may store at least one of information transmitted/received via the transceiver 1005 and information generated via the controller 1010.

Methods disclosed in the claims and/or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program may include instructions that cause the electronic device to perform the methods according to various embodiments of the disclosure as defined by the appended claims and/or disclosed herein.

These programs (software modules or software) may be stored in non-volatile memories including a random access memory and a flash memory, a read only memory (ROM), an electrically erasable programmable read only memory (EEPROM), a magnetic disc storage device, a compact disc-ROM (CD-ROM), digital versatile discs (DVDs), or other type optical storage devices, or a magnetic cassette. Alternatively, any combination of some or all of them may form a memory in which the program is stored. In addition, a plurality of such memories may be included in the electronic device.

Moreover, the programs may be stored in an attachable storage device which may access the electronic device through communication networks such as the Internet, Intranet, local area network (LAN), wide LAN (WLAN), and storage area network (SAN) or a combination thereof. Such a storage device may access the electronic device via an external port. Furthermore, a separate storage device on the communication network may access a portable electronic device.

In the above-described detailed embodiments of the disclosure, an element included in the disclosure is expressed in the singular or the plural according to presented detailed embodiments. However, the singular form or plural form is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Furthermore, the above respective embodiments may be employed in combination, as necessary.

In the drawings in which methods of the disclosure are described, the order of the description does not always correspond to the order in which steps of each method are performed, and the order relationship between the steps may be changed or the steps may be performed in parallel.

In the drawings in which methods of the disclosure are described, the order of the description does not always correspond to the order in which steps of each method are performed, and the order relationship between the steps may be changed or the steps may be performed in parallel.

Furthermore, in methods of the disclosure, some or all of the contents of each embodiment may be combined without departing from the essential spirit and scope of the disclosure.

The embodiments of the disclosure described and shown in the specification and the drawings are merely specific examples that have been presented to easily explain the technical contents of embodiments of the disclosure and help understanding of embodiments of the disclosure, and are not intended to limit the scope of embodiments of the disclosure. That is, it will be apparent to those skilled in the art that other variants based on the technical idea of the disclosure may be implemented. Furthermore, the above respective embodiments may be employed in combination, as necessary. For example, all embodiments of the disclosure may be partially combined to operate a base station and a terminal.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a first node in a communication system, the method comprising:
obtaining vulnerability-related information associated with the communication system;
receiving, from a second node, a first message comprising a request for a security-related service; and
providing, based on the vulnerability-related information, a second message comprising the security-related service.

2. The method of claim 1, wherein the first node is a first network function (NF) included in a core network of the communication system, and
wherein the first node is configured to provide the security-related service.

3. The method of claim 1, wherein, in case that the second message is provided to a second NF included in a core network of the communication system, the second message is provided to the second NF based on a service-based interface (SBI) exhibited by the first node.

4. The method of claim 1, wherein, in case that the second message is provided to an application function (AF), the second message is provided from the first node to the AF via a network exposure function (NEF) included in a core network of the communication system,
wherein a service-based interface (SBI) exhibited by the first node is configured between the first node and the NEF, and
wherein an outbound restriction is applied, by the NEF, to the second message provided to the AF based on exposure mapping.

5. The method of claim 1, wherein, in case that the vulnerability-related information is obtained from a third NF included in a core network of the communication system, obtaining the vulnerability-related information comprises:
transmitting, to the third NF via an SBI exhibited the third NF, a request message comprising a request for the vulnerability-related information; and
obtaining, from the third NF via the SBI exhibited the third NF, a response message comprising the vulnerability-related information.

6. The method of claim 5, wherein the vulnerability-related information comprises at least one of:
a request message comprising a request for the vulnerability-related information from among a list of network entities (NEs) on known vulnerabilities included in the communication system,
a list of UEs on known vulnerabilities included in the communication system,
a list of NFs on known vulnerabilities included in the communication system,
a list of access networks (ANs) on known vulnerabilities included in the communication system,
a list of vendors on known vulnerabilities,
a list of products on known vulnerabilities,
a list of versions on known vulnerabilities,
common vulnerabilities and exposure (CVE),
a common vulnerability scoring system (CVSS),
CVE numbering authority (CNA), or
common weakness enumeration (CWE).

7. The method of claim 1, wherein the security-related service is identified based on an analysis result associated with the vulnerability-related information, and
wherein, for obtaining analysis result associated with the vulnerability-related information, a correlation between at least some of multiple nodes included in the communication system is identified based on predefined correlation information.

8. The method of claim 1, wherein, in case that the first message comprises information associated with a number of times for the second message, the second message is provided by the number of times,
wherein, in case that the first message comprises information associated with a periodic provision associated with the second message, the second message is provided periodically,
wherein, in case that the first message comprises information associated with a non-periodic provision associated with the second message, the second message is provided non-periodically,
wherein, in case that the first message comprises information associated with an object of a security-related service, the second message is provided based on vulnerability-related information associated with the object, and
wherein, in case that the first message comprises information associated with a target address of the second message, the second message is provided to a node identified by the target address.

9. The method of claim 8, wherein, in case that the request for the security-related service is a request for subscription to the security-related service, the second message is provided based on the subscription,
wherein, in case that the request for the security-related service is a one-time request, the second message is provided for one time, and
wherein the information associated with the number of times that the second message is provided, the information associated with a periodic provision, the information associated with a non-periodic provision, and the information associated with a target address is included in the first message, in case that the request for the security-related service is a request for subscription to the security-related service.

10. The method of claim 1, wherein the second message comprises:
information associated with a timestamp indicating a timepoint at which the first node generates the security-related service based on the vulnerability-related information; and
information associated with a validity duration from a timepoint at which the security-related service is generated to a timepoint at which the security-related service is identified as being valid.

11. A first node of a communication system, the first node comprising:
a transceiver; and
a processor operably connected to the transceiver, the processor configured to:
obtain vulnerability-related information associated with the communication system;
receive, from a second node, a first message comprising a request for a security-related service; and
providef, based on the vulnerability-related information, a second message comprising the security-related service.

12. The first node of claim 11, wherein the first node is a first network function (NF) included in a core network of the communication system, and
wherein the first node is configured to provide the security-related service.

13. The first node of claim 11, wherein, in case that the second message is provided to a second NF included in a core network of the communication system, the second message is provided to the second NF based on a service-based interface (SBI) exhibited by the first node.

14. The first node of claim 11, wherein, in case that the second message is provided to an application function (AF), the second message is provided from the first node to the AF via a network exposure function (NEF) included in a core network of the communication system,
wherein a service-based interface (SBI) exhibited by the first node is configured between the first node and the NEF, and
wherein an outbound restriction is applied, by the NEF, to the second message provided to the AF, based on exposure mapping.

15. The first node of claim 11, wherein, in case that the vulnerability-related information is obtained from a third NF included in a core network of the communication system, the processor is configured to:
transmit, to the third NF via an SBI exhibited the third NF, a request message comprising a request for the vulnerability-related information; and
obtain, from the third NF via the SBI exhibited the third NF, a response message comprising the vulnerability-related information.

16. The first node of claim 15, wherein the vulnerability-related information comprises at least one of:
the a request message comprising a request for the vulnerability-related information from among a list of network entities (NEs) on known vulnerabilities included in a communication system,
a list of UEs on known vulnerabilities included in the communication system,
a list of NFs on known vulnerabilities included in the communication system,
a list of access networks (ANs) on known vulnerabilities, included in the communication system, a list of vendors on known vulnerabilities,
a list of products on known vulnerabilities,
a list of versions on known vulnerabilities,
common vulnerabilities and exposure (CVE),
a common vulnerability scoring system (CVSS),
CVE numbering authority (CNA), or
common weakness enumeration (CWE).

17. The first node of claim 11, wherein the security-related service is identified based on an analysis result associated with the vulnerability-related information, and
wherein, for obtaining analysis result associated with the vulnerability-related information, a correlation between at least some of multiple nodes included in the communication system is identified based on predefined correlation information.

18. The first node of claim 11, wherein, in case that the first message comprises information associated with a number of times for the second message, the second message is provided by the number of times,
wherein, in case that the first message comprises information associated with a periodic provision associated with the second message, the second message is provided periodically,
wherein, in case that the first message comprises information associated with a non-periodic provision associated with the second message, the second message is provided non-periodically,
wherein, in case that the first message comprises information associated with an object of a security-related service, the second message is provided based on vulnerability-related information associated with the object, and
wherein, in case that the first message comprises information associated with a target address of the second message, the second message is provided to a node identified by the target address.

19. The first node of claim 18, wherein, in case that the request for the security-related service is a request for subscription to the security-related service, the second message is provided based on the subscription,
wherein, in case that the request for the security-related service is a one-time request, the second message is provided for one time, and
wherein the information associated with the number of times that the second message is provided, the information associated with a periodic provision, the information associated with a non-periodic provision, and the information associated with a target address is included in the first message, in case that the request for the security-related service is a request for subscription to the security-related service.

20. The first node of claim 11, wherein the second message comprises:
information associated with a timestamp indicating a timepoint at which the first node generates the security-related service based on the vulnerability-related information; and
information associated with a validity duration from a timepoint at which the security-related service is generated to a timepoint at which the security-related service is identified as being valid.
